(19) United States
(12) Patent Application Publication
(10) Pub. No.: US 2021/0301795 A1
(43) Pub. Date: Sep. 30, 2021

(54) GENERATOR SYSTEM UTILIZING WEIGHTS OF RECURRENT STATIC LOADS

(71) Applicant: Musbah ALI LAHIB, Sharjah (AE)

(72) Inventor: Musbah ALI LAHIB, Sharjah (AE)

(21) Appl. No.: 17/264,906

(22) PCT Filed: Aug. 2, 2018
(86) PCT No.: PCT/IB2018/000820

§ 371 Date: Feb. 1, 2021

(51) Int. Cl. F03G 3/08; H02K 7/116; H02K 7/18

(52) U.S. Cl. CPC F03G 3/08; F03B 17/025; H02K 7/1853; H02K 7/116

(57) ABSTRACT

A generator system that includes a platform configured to support a load (FIG. 1). The platform is located in an area at which loads are present for a certain period of time on a recurrent basis. That is, loads that undergo recurrent loading and unloading, wherein loads on the platform will cause compression of the platform thereby generating motive power. The generator system includes a generator operatively connected to the belt and configured to convert at least a portion of the motive power into electric energy. The generator system further includes an automatic transmission box configured to translate the at least a portion of the motive power to the generator.

### TECHNICAL FIELD

The present disclosure relates to a generator system utilizing the weights of loads that are present in a certain area for a certain period of time on a recurrent basis. That is, loads that undergo recurrent loading and unloading. Examples of such loads include but are not limited to vehicles in parking, ports, airports, etc., cargo/merchandise on top of ships, trucks, trains, etc., luggage/cargo/merchandise in stores, airports, ports, etc., people seated in theatres, polyvalent rooms, stadiums, waiting areas etc. or in vehicles, bicycles, chairs etc. and water in rivers or accumulated rain water. The term loads in this context includes but is not limited to vehicular and non-vehicular loads, where vehicular loads include land, air and water vehicles such as bikes, bicycles, automobiles, trucks, trains, ships, helicopters and airplanes. Non-vehicular loads include but are not limited to cargo, merchandise, luggage, animals, people and water.

The present disclosure relates to a generator system utilizing the weights of loads, including but not limited to merchandise, cargo, vehicles, people, animals, rain, snow, sand, soil, rocks, rivers, wastes or any other weights. This generator system may be used in:

Unloading and loading areas of ports, airports, cargo centers, logistic centers, storage facilities, farms, factories, etc.

Areas where vehicles' assembly is on a regular basis such as but not limited to stop light areas, parking facilities of vehicles, including single level parking, multi-level parking and individual, public, private parking, etc.

Vehicles, especially cargo ships, trains and trucks.

Chairs, especially the seating of bikes and bicycles.

People assembly areas, such as but not limited to temples, stadiums, cinemas, theatres, classrooms, polyvalent rooms, and waiting areas, especially in train and metro stations and air or land ports.

Animal barns and areas in which animals are grouped.

Areas where snow and rain water accumulate, whether the areas are natural or humanmade.

Rivers

Areas of rock, sand, and soil extraction and accumulation.

### BACKGROUND

There is a growing need for a clean and sustainable energy resource. Such a need is due to the current dependence on fossil fuels for power generation, which is causing their depletion and is negatively impacting the ecosystem. Therefore, and due to the ever-increasing demand for clean and sustainable energy, technologies for harvesting readily available, clean and sustainable energy are being researched.

### BRIEF DESCRIPTION OF THE DRAWINGS

FIG. 1 is a schematic illustration of a generator system according to one exemplary approach.

FIG. 2 is a schematic illustration of the generator system of FIG. 1, it depicts the inventive platform in its compressed position (FIG. 2a) and in its expanded position (FIG. 2b).

FIG. 3 is a schematic illustration of the generator system of FIGS. 1-2 wherein the platform is configured in a parking area and is carrying a parked vehicle on top of it.

FIG. 4 is a schematic illustration of the generator system of FIGS. 1-2 configured on a bicycle seat.

FIG. 5 is a schematic illustration of the generator system of FIGS. 1-2 configured in a river; FIG. 5a is a transversal section of the river that shows the two, empty and full, sections of the river with their two platforms; FIG. 5b shows a longitudinal section of the full section of the river and its compressed platform; FIG. 5c shows a longitudinal section of the empty section of the river and its expanded platform, FIG. 5d shows a plan view of the two sections of the river while one is empty and one is full of water.

### DETAILED DESCRIPTION

It should be noted that the descriptions set forth herein are not intended to be exhaustive, otherwise limit, or restrict the claims to the precise forms and configurations shown in the drawings and disclosed in the following detailed description.

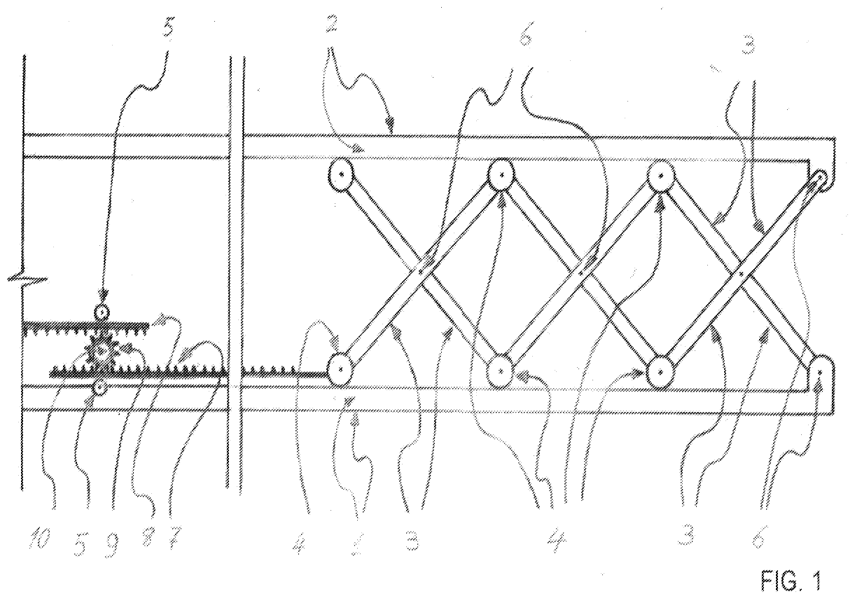

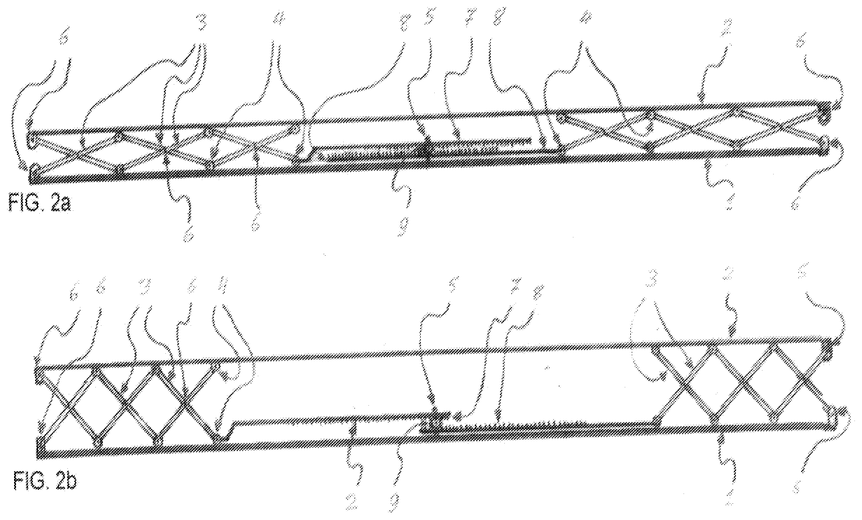

The generator system, illustrated in FIGS. 1-2, comprises of an inventive platform that consists of an upper section (2) and a lower section (1). The lower section (1) is stationary while the upper section (2) is capable of moving in the downward and upward directions. The upper (2) and lower (1) sections of the platform are connected to each other via folding supports in a criss-cross pattern (scissor arms) (3), two gear racks (7, 8) and a gear (9). In the axis of the gear (9) there exists a shaft (10) such that the rotation of the gear (9) causes the rotation of the shaft (10) in one direction only. That is, rotation of the gear (9) in the second direction will not cause rotation of the shaft (10).

The upper (2) and lower (1) sections of the platform have tracks on their inner sides and the scissor arms (3) in between have wheels (4) in contact with each of the sections. At the terminal of each of the platform sections, the scissor arms are connected to the sections via fixed hinges (6). Pulleys (5) are utilized to keep the gear racks (7, 8) from moving away from the gear (9). The weight of the load carried on the platform causes the compression of the platform (FIG. 2a) thereby extending the scissor arms (3) by moving the wheels (4) on their tracks and pushing the gear racks (7, 8) horizontally, which subsequently causes the rotation of the gear (9) and its shaft (10). The movement generated by the rotation of the shaft (10) is then utilized for power generation via an automatic transmission box and a cruise control system. When the load is removed from above the platform, the upper section of the platform (2) is lifted back to its upward, initial position (FIG. 2b) while the scissor arms (3) return to their retracted position and the gear (8) rotates on the gear racks (7, 8) returning to its initial position without rotating the shaft (10) in the axis of the gear (9). The lifting can be done by means of springs, a motor that uses a portion of the energy generated by the shaft or mechanically using the weight of the vehicle as it leaves the platform. The springs' power of lifting suit the weight of the deserted platform, which is designed with minimum weight to minimize the power needed for lifting it. The power generated is the balance between the power generated by the weight of the load compressing the platform and the power needed to lift the deserted platform.

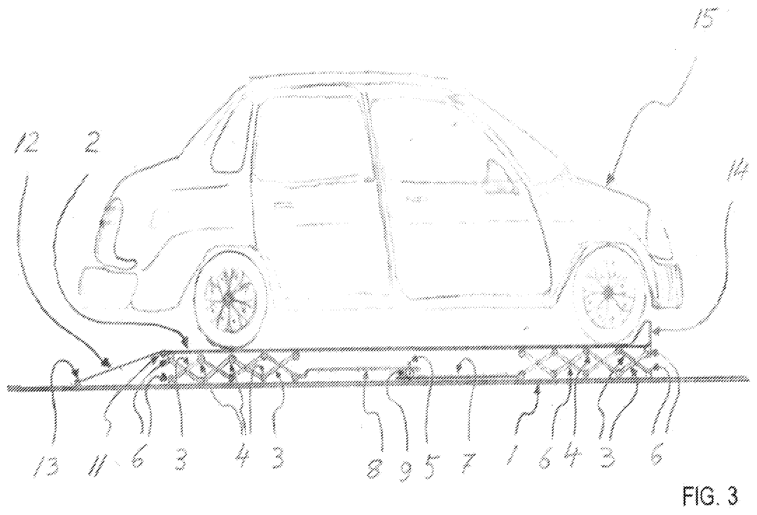

In the case of vehicle parking facilities (FIG. 3), the platform is further equipped with a stopper (14) and a ramp (12) that is connected to the platform via a hinge (11) and that is able to accommodate the compression and expansion of the platform via a wheel (13) at the ramp's (12) terminal.

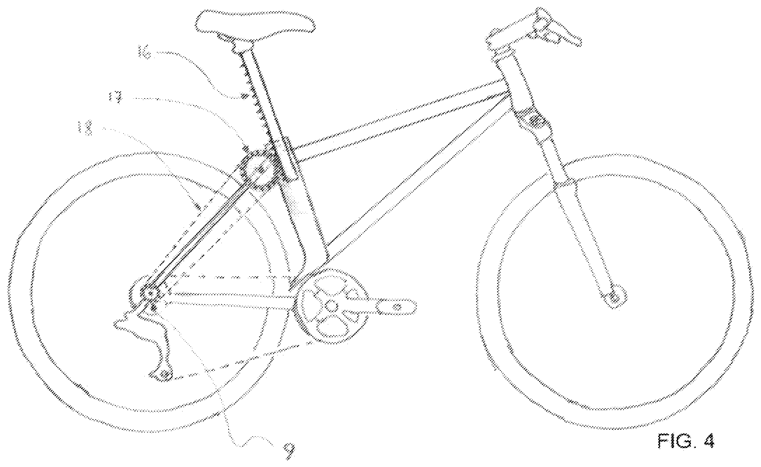

In the case of bicycles or desk chairs, the seatpost of the seat will serve as the gear rack such that the weight of the person on the seat compresses the seat and hence the gear rack which rotates the double gear and its roller chain (FIG. 4). Like in the case of the shaft, the roller chain is capable of rotating in one direction only. The movement of the roller chain is transmitted via an automatic transmission box and a cruise control system to the wheels of the bicycle or is stored as energy in springs or any other means of energy storage. If and when the cyclist wants to recharge their bicycle, they are only required to lift their body from above the bicycle's saddle so that it rises to its initial position. The cyclist then sits on the bicycle's saddle to compress it again and so on and so forth. This can also be applied to any seat.

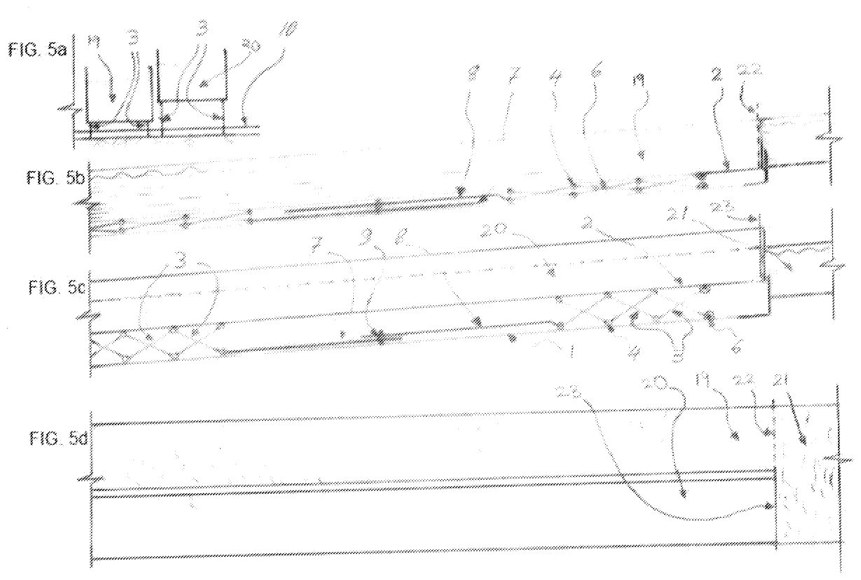

In the case of rivers (FIG. 5), a portion of the river (21) is split longitudinally into two or more sections (19, 20), where each section is a channel of the river (21) carried on the novel platform. The first section has an open gate (22), is water filled (19) and its platform is compressed (FIG. 5b) while the second section has a closed gate (23), is empty (20), and its platform is in the expanded position (FIG. 5c). Then, the first river channel in the first section is closed and its platform goes to the upward position and the second river channel in the second section opens so that its platform is compressed by the incoming water and so on and so forth (FIG. 5a and 5d).

It is intended that the scope of the present methods and apparatuses be defined by the following claims. However, it must be understood that the disclosed system may be practiced otherwise than is specifically explained and illustrated without departing from its spirit or scope. It should be understood by those skilled in the art that various alternatives to the configuration described herein may be employed in practicing the claims without departing from the spirit and scope as defined in the following claims. The scope of the disclosure should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples.

Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. It is intended that the following claims define the scope of the device and that the method and apparatus within the scope of these claims and their equivalents be covered thereby. In sum, it should be understood that the device is capable of modification and variation and is limited only by the following claims.

1—Lower section of the inventive platform

2—Upper section of the inventive platform

3—Scissor arms

4—Wheels

5—Pulley

6—Hinges

7—Lower gear rack

8—Upper gear rack

9—Gear

10—Shaft

11—Hinge

12—Ramp

13—Wheel

14—Stopper

15—Vehicle

16—Gear rack

17—Double gear

18—Roller chain

19—Filled section

20—Empty section

21—River

22—Open gate

23—Closed gate

What is claimed is:

1. A generator system comprising:
a platform configured to support a load (FIG. 1), the platform comprising a lower, static section (1) that is connected to an upper section (2) capable of moving in the upward and downward directions, wherein compression of the platform (FIG. 2a) that is caused by the static load on it generates motive power;
a generator operatively connected to the platform and configured to convert at least a portion of the motive power into electric energy;
an automatic transmission box configured to translate the at least a portion of the motive power to the generator.

2. The generator system of claim 1, wherein the upper (2) and lower (1) sections of the platform are connected via folding supports in a criss-cross pattern (scissor arms) (3), wheels (4), two gear racks (7, 8) and a gear (9) through which a shaft (10) rotates upon compression of the platform only and not upon its expansion.

3. The generator system of claim 1, wherein a static load on the platform compresses it thereby extending the scissor arms (3) by moving the wheels (4) on their tracks and pushing the gear racks (7, 8) horizontally, which subsequently causes the rotation of the gear (9) and its shaft, generating motive power.

4. The generator system of claim 1, wherein the platform is configured in unloading and/or loading areas of ports, airports, cargo centers, logistic centers, storage facilities, farms, factories, etc.

5. The generator system of claim 1, wherein the platform is configured in people assembly areas, such as but not limited to temples, stadiums, cinemas, theatres, classrooms, polyvalent rooms, and waiting areas, especially in train and metro stations and air or land ports.

6. The generator system of claim 1, wherein the platform is configured in animal barns and areas in which animals are grouped.

7. The generator system of claim 1, wherein the platform is configured in vehicles, especially cargo ships, trains and trucks.

8. The generator system of claim 1, wherein the load is a vehicle and the platform is configured in a parking area; the generator system further comprising a stopper (14) and a ramp (12) that is connected to the platform via a hinge (11) and that is in contact with the ground via a wheel (13).

9. The generator system of claim 1, wherein the platform is configured in a bicycle or a desk chair such that the seat post serves as the gear rack (16).

10. The generator system of claim 1, wherein the platform is configured in areas where snow or water accumulate.

11. The generator system of claim 1, wherein the platform is configured in areas of rock, and and/or soil extraction and/or accumulation.

12. The generator system of claim 1, wherein the load is a river (21) that is sectioned longitudinally into two sections or more (19, 20) and a platform is configured on each section of the river bed.

13. The generator system of claim 4, wherein the first section has an open gate (22), is water filled (19) and its platform is compressed (FIG. 5b) while the second section has a closed gate (23), is empty (20), and its platform is in the expanded position (FIG. 5c). Then, the first river channel in the first section is closed and its platform goes to the upward position and the second river channel in the second section opens so that its platform is compressed by the incoming water and so on and so forth (FIG. 5a and 5d).
